(19) United States
(12) Patent Application Publication
(10) Pub. No.: US 2005/0273453 A1
(43) Pub. Date: Dec. 8, 2005

(54) Systems, apparatus and methods for performing criminal background investigations

(75) Inventor: Robert W. Holloran, Ocala, FL (US)

Correspondence Address: Douglas Wm. Massinger, Esquire;MASSINGER LAW OFFICES, 887 N.E. 100 Street, Ocala, FL, 34479, US

(73) Assignee: NATIONAL BACKGROUND DATA, LLC

(21) Appl. No.: 10/861,966

(22) Filed: Jun. 5, 2004

(51) Int. Cl. G06F 7/00

(52) U.S. Cl. 707/1

(57) ABSTRACT

An automated system for performing criminal background investigations of individuals comprising at least one investigator having access to at least one address information database and at least one criminal history database, the investigator having apparatus for recording personal identification information of a subject and for generating electronic reports relating to the criminal history of the subject; and a search architecture responsive to inputs by the at least one investigator for causing a search of each database, for processing the corresponding search results to 1) eliminate those criminal records which do not relate to the subject, 2) identify and report those criminal records which do relate to the subject, and 3) identify and report those criminal records which may relate to the subject and require further investigation.

### FIELD OF THE INVENTION

The subject invention relates to the performance of criminal background checks in general, and to systems, apparatus and methods for investigating the criminal history of an individual while minimizing false positive and false negative results, in particular.

### BACKGROUND OF THE INVENTION

Federal law does not permit access to the FBI's national criminal history database for most private sector criminal history background checks. When access to the FBI's database is authorized for non-criminal justice employment screening purposes, the checks are fingerprint-based to ensure that the results of the checks apply to the person whose fingerprints were submitted.

Most private sector criminal history background checks for employment and tenant screening purposes are conducted by “consumer reporting agencies” (typically background screening companies) using the applicant's name and date of birth to search commercial databases and state and local government archives of criminal history records. Several private sector companies, including National Background Data, LLC, have compiled databases that include criminal history records from most, but not all of the states.

The applicant's name and date of birth are insufficiently unique to assure that the results of private criminal history database searches apply to the applicant. The term “false positive” refers to a record that does not apply to the applicant even though the name and date of birth in the record matches the applicants. However, the Fair Credit Reporting Act (FCRA) § 607(b) requires “reasonable procedures to assure maximum possible accuracy of the information concerning the individual about whom the report relates.” When information on consumers, which are matters of public record, such as arrests, indictments, convictions, and are likely to have an adverse effect upon a consumer's ability to obtain employment, FCRA § 613 requires either strict procedures to ensure that the reported information is complete and up to date, or notification of the consumer of the fact that public record information is being reported.

Criminal background checks are also conducted for legitimate investigative purposes that are not regulated by the FCRA. However, privacy concerns also dictate that the results of these checks relate to the person being investigated, so the invention is also useful for these purposes, as well.

The term “false negative” refers to a record that applies to the applicant, but was not found because the name and/or date of birth in the record does not match the name and/or date of birth that the applicant provided or the search did not check the records of the jurisdiction where the offense occurred. To reduce the potential for “false negatives” a variety of techniques may be used. For example, to determine where more detailed onsite searches of county court records are necessary, background screening companies frequently search proprietary databases of residence address information using the applicant's social security number to identify any jurisdictions where the applicant may have previously resided, but for which the private criminal history databases they use do not provide adequate coverage. Other examples of techniques that broaden the search criteria involve using: (1) only the first few letters of the first name, or tables of nick names, for example, Bob or Rob, for Robert, (2) SOUNDEX, which was developed by the Census Bureau for the 1880 census, to identify alternate spellings of last names, and (3) near matches of the date of birth or elimination of the date of birth entirely as a search parameter. However, for most pre-employment and tenant screening background checks, these techniques are not practical, since they usually result in substantially greater numbers of false positives that require human intervention and additional research to eliminate obvious false positives in order to comply with FCRA § 607(b).

Even when the searches are based only on matches of the exact name and date of birth, commercial criminal history database checks still have to be augmented with costly onsite searches of the court records identified by the database searches to locate information in the full court records that will provide confirmation that the records do or do not apply to the applicants. Even these confirmation efforts are being hindered by the trend by courts to remove personal identifiers from public records to reduce the potential for identify theft. No known means exist for minimizing the need for locating additional identifiers to determine the applicability of results of searches without additional identifiers or fingerprints.

### SUMMARY OF THE INVENTION

The subject invention more specifically relates to systems, methods and software-implemented devices for investigating the criminal history of individuals such as job applicants, loan applicants and the like. In a preferred embodiment, a system of the invention is comprised of at least one investigator having electronic access to at least one proprietary address information database comprised of electronic documents that contain names, addresses, social security numbers and dates of birth, each of such documents being searchable by entering the Applicant's social security number on the one hand, or by entering the Applicant's first and last names and date of birth on the other hand, and to at least one criminal history database comprised of electronic documents that contain criminal history information of individuals, each of such documents being searchable by entering the Applicant's first and last names and date of birth or social security number. The system further includes a search architecture responsive to inputs by the Investigator for causing or initiating searches of each database, for processing the corresponding search results as described in detail herein, and for producing a search report for display and/or printing. The search architecture includes a software application which may be developed in a variety of programming languages. The application is built around the following basic types of database queries or query sets:
1) A query set of the address information database based upon an initial query of the Applicant's social security number (to identify any other names the Applicant may have used, for example, a married woman's maiden name) and a subsequent query upon that results set using name and date of birth (to eliminate returned records that include the Applicant's social security number, but which have name and address data for a totally different person because they had been incorrectly entered and recorded in the address information database). In reference to the date of birth, there are in fact some cases where the address information database may not contain the date of birth, but rather an estimated age. Where the instances of an estimated age occur, further analysis in the form of a range comparison would be executed to determine the applicability of the record to the Applicant. However, for purposes of the descriptions embodied herein, the term “date of birth” will be used to describe both instances, to wit, the actual date of birth or an estimated age comparison process.
2) A query of the criminal history database based upon each unique variation of the Applicant's first and/or last names and date of birth to find those criminal history records that correspond to those name variations (and therefore possibly the Applicant) and the state that was the source of each such record.
3) A query of the address information database based upon each unique variation of the Applicant's first and last names and date of birth generated by Query 2 above to identify other address records with the same first and last names and dates of birth as the Applicant.

Queries 1) and 2) are the basis of current best practice in the professional background screening industry. Query 3) provides additional information about the Applicant and others with the same names and date of birth that can be automatically compared. Execution of subsequent Queries will: broaden the geographic search range by incorporating nearby (surrounding) state information as a basis of further searches; narrow the list of potential Applicant records to those records in nearby states; and, based on automated decisioning logic, determine the need to select criminal history offender and offenses records for either reporting or further investigation. The net effect of the subsequent Queries allows further costly, on-site investigations to be avoided, while achieving “maximum possible accuracy of the information concerning the individual (Applicant) about whom the report relates.”

A significant advantage of the application is that costly, on-site investigations are only required to complete a background screening when: (1) the Applicant and at least one other person with the Applicant's identifying information resided in the state of record or surrounding states, or (2) no one with the Applicant's name and date of birth resided in-the state of record or surrounding states. The ensuing detailed description includes an embodiment employing web-based application development tools that query “The National Background Directory™” criminal history database compiled by National Background Data, LLC and any of several commercial address information databases.

Consistent with the foregoing, the invention also provides associated methods.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including- such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is, therefore, a primary object of the subject invention to provide systems, apparatus and methods for investigating the criminal history of individuals in a manner that reduces the number of false positive results from those heretofore observed with systems, apparatus and methods of the prior art.

Another primary object of the subject invention is to provide systems, apparatus and methods for investigating the criminal history of individuals in a manner that reduces the number of false negative results by permitting broader search criteria, since efficient means are provided to eliminate the additional false positive results generated by the broader search criteria.

Still another primary object of the subject invention is to provide systems, apparatus and methods for investigating the criminal history of individuals in a manner that produces criminal history results which are in compliance with the Fair Credit Reporting Act § 607(b) which mandates “reasonable procedures to assure maximum possible accuracy of the information concerning the individual about whom the report relates.”

These together with other objects of the invention, along with the various features of novelty which characterize the invention, are pointed out with particularity in the claims annexed to and forming a part of this disclosure. For a better understanding of the invention, its advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed flow diagrams and drawings wherein:

FIG. 1 shows the basic data structure of an address information database table of Names and Addresses;

FIG. 2 shows the basic data structure of a criminal history database table of Offenders;

FIG. 3 shows the basic data structure of a criminal history database table of Offenses;

FIG. 4 shows the basic data structure of a criminal history database of Nearby States;

FIG. 5A illustrates the Initiating (Main) Process flow of the invention;

FIG. 5B illustrates the recursive process, identified as Process A, whereby Criminal History records are selected;

FIG. 5C illustrates the recursive process, identified as Process B, whereby Address Information is re-queried based upon Criminal History records and nearby states are selected;

FIG. 5D illustrates the recursive process, identified as Process C, for matching and reasonably determining if the Applicant is the offender in compliance with the Fair Credit Reporting Act § 607(b);

FIG. 6 shows the input screen presented to the user for entering information required to conduct a background screening (with sample data);

FIG. 7 shows the basic structure of a table of screening orders in the criminal history database (with sample data);

FIG. 8 describes the queries of Query Set 1 where the names and addresses in the address information database are initially selected by the Applicant's social security number (SSN), and the results set selected by the Applicant's date of birth (DOB);

FIG. 9 describes the result set of Query 1b where combinations of the Applicant's first and last name are returned with associated addresses, dates of birth (DOB) and social security number (SSN) (with sample data);

FIG. 9A describes the result set of Query 1c where UNIQUE combinations of the Applicant's first and last name are returned with associated addresses, dates of birth (DOB) and social security number (SSN) (with sample data);

FIG. 10 describes Query 2 where records from the table of offenders in the criminal history database with the Applicant's name and date of birth are returned;

FIG. 11 describes the result set of Query 2 that returns offender records in the criminal history database Offenders Table that have the Applicant's first name, last name and date of birth (with sample data);

FIG. 12 describes Query 3 which selects records with unique first name, last name and dates of birth from the address information database table of Names and Addresses using the result set of Query 2;

FIG. 13 describes the result set of Query 3 that returns name, address, DOB and SSN of the individuals in the address information database associated with criminal history offender records that match the Applicant's first name, last name and date of birth (with sample data);

FIG. 14 describes the queries of Query Set 4 where nearby states are identified from a criminal history table of nearby states based upon the states of record in the Query 2 result set (with sample data);

FIG. 15 describes the queries of Query Set 5 where records from the result set of Query 3 are selected based upon nearby states identified in Query Set 4 results sets and the disposition of those records using the Results Matrix described in FIG. 16 (with sample data);

FIG. 16 describes the Results Matrix for record disposition used in Query Set 5;

FIG. 17 describes the result set from Query Set 5 (with sample data);

FIG. 18 describes the queries of Query Set 6 where offender records are selected from the criminal history offender and offense tables results set from Query Set 5 whose disposition result is either “Applicant” or “Investigate” (with sample data);

FIG. 19 describes the final result set from Query 6 to be saved in an Investigation Results table with Offender and Offense records to be reported or investigated (with sample data).

### DETAILED DESCRIPTION OF THE PREFERRED EMBODIMENT

The subject invention relates to systems, methods and software-implemented devices for investigating the criminal history of individuals such as job applicants, loan applicants, prospective tenants and the like (hereinafter collectively referred to as an “Applicant”). In a preferred embodiment, a system of the invention is comprised of at least one investigator (hereinafter “Investigator”) having electronic access to: 1) at least one proprietary address information database (“Address Information Database”) comprised of electronic documents that contain, inter alia, addresses, each of such documents being searchable by entering the Applicant's social security number (“SSN”) on the one hand, or by entering the Applicant's first and last name and date of birth on the other hand, and 2) to at least one criminal history database (“Criminal History Database”) comprised of electronic documents that contain criminal history information of individuals, each of such documents being searchable by entering the Applicant's first and last names and date of birth. Both the Address Information Database and the Criminal History Database are stored on at least one personal computer or computer server (not shown) which normally includes or is otherwise associated with internal and external data storage means and media, processing apparatus, an appropriate software architecture, a monitor, input apparatus such as a keyboard, mouse or pointing device and a printer. The personal computer or computer server may be part of a network comprised of either or both a generalized network environment or the Internet. The system generally, and software architecture in particular, further includes a search architecture responsive to inputs by the Investigator for causing or initiating searches of each database, for processing the corresponding search results as described in detail herein, and for producing a search report for display and/or printing. The software architecture is comprised of at least one software application which may be developed in a variety of programming languages to carry out the steps of the methods described herein.

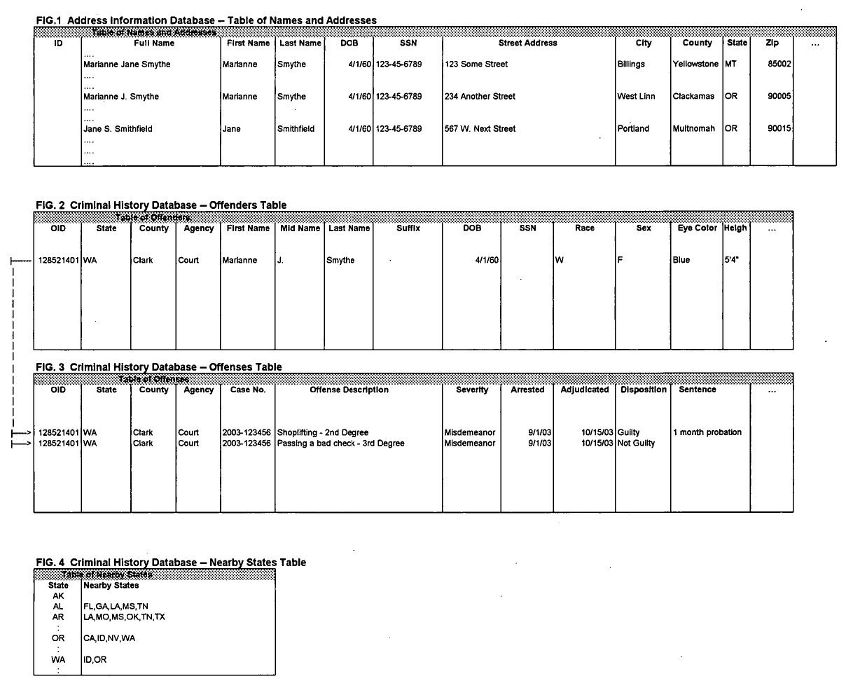

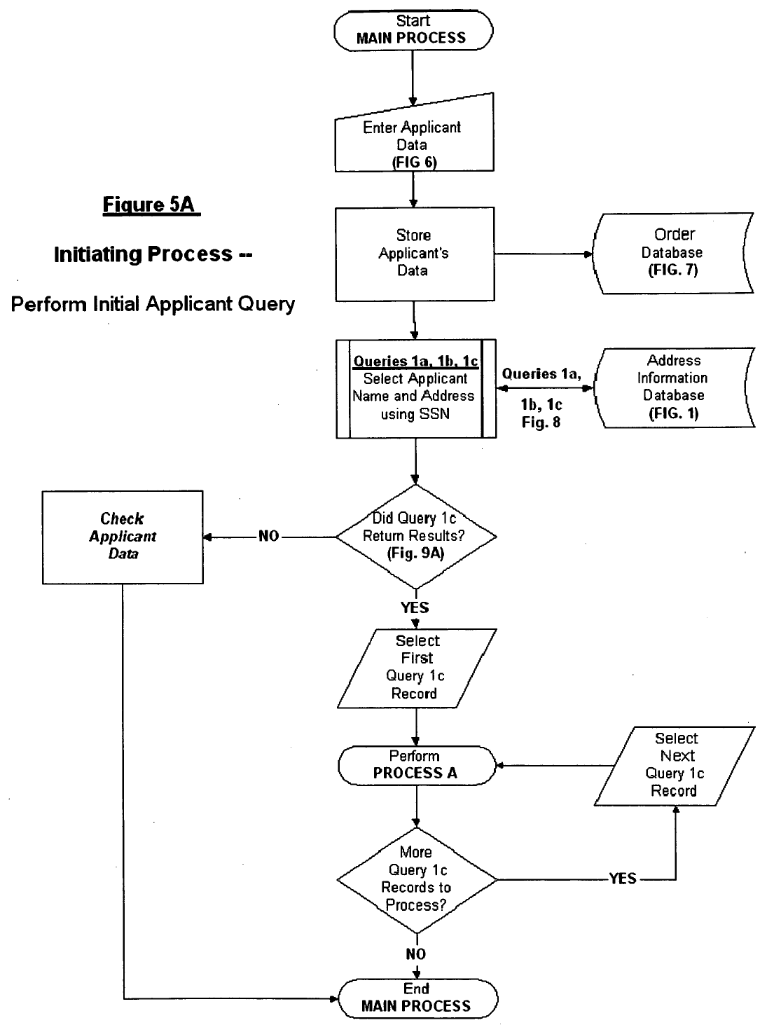

Reference is now made to FIG. 1 in which there is illustrated in diagrammatic form a preferred embodiment of the structure of a typical Address Information Database of the subject invention together with sample data. The essential elements of the Address Information Database are: (1) a data structure that includes a table of names and addresses, or combinations of tables that link the occupant's names and their addresses, and (2) a plurality of records with fields for each element of an individual's name, that is, first name, middle name, last name and suffix, the individual's date of birth (DOB) or approximate age, and the individual's complete or truncated social security number (SSN). Means for searching the records based upon various combinations of input parameters in the table of names and addresses (hereinafter “search architecture”) are also provided and associated with the Address Information Database.

The preferred embodiment uses two types of queries of the table of names and addresses: (1) queries based upon an Applicant's social security number (SSN) and (2) queries based upon the Applicant's first name, last name and date of birth (DOB). The output of these queries include the full names and addresses associated with the input query, where the address information returned include the street address, city, county, state and zip code for each address record in the query results, along with the social security number and date of birth.

The information contained in the Address Information Databases of the subject invention come from both public sources (for example, telephone-books) and private sources (for example, credit bureaus, customer mailing lists, etc.) The FCRA restricts the sources of address information that may be used in conjunction with granting of credit, employment decisions, and other purposes it regulates. These restrictions do not apply to criminal history background checks conducted for non-regulated investigative purposes. The subject invention does not depend on what sources of the address information are included in the Address Information Database, or which of several commercially available Address Information Databases is used, although some of the original sources of data used for FCRA-regulated purposes may be different from the sources used for non-regulated purposes.

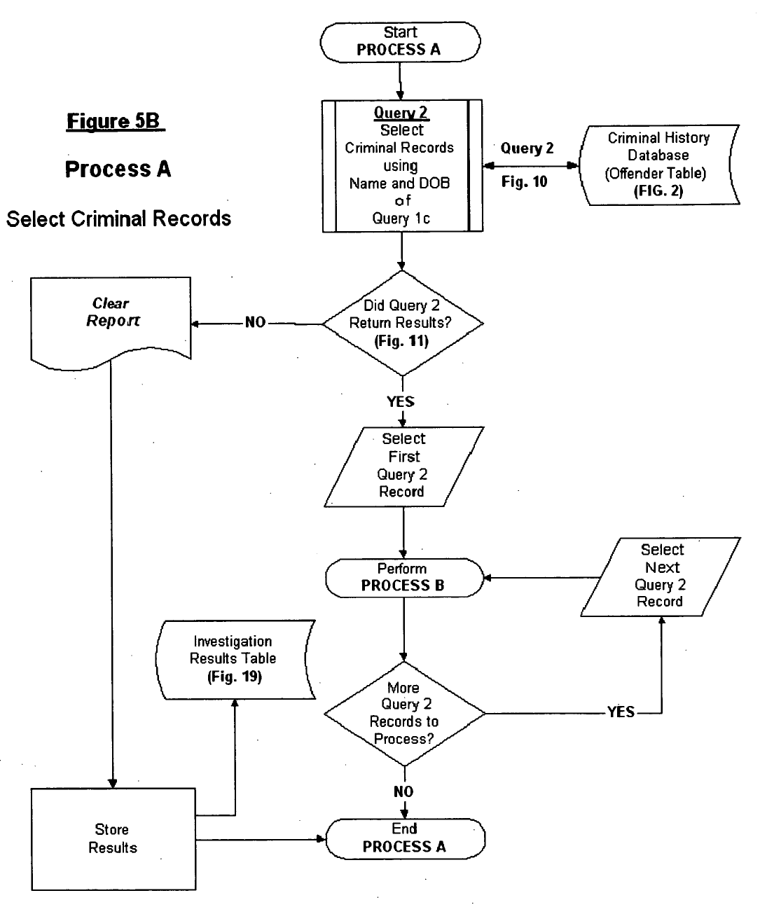

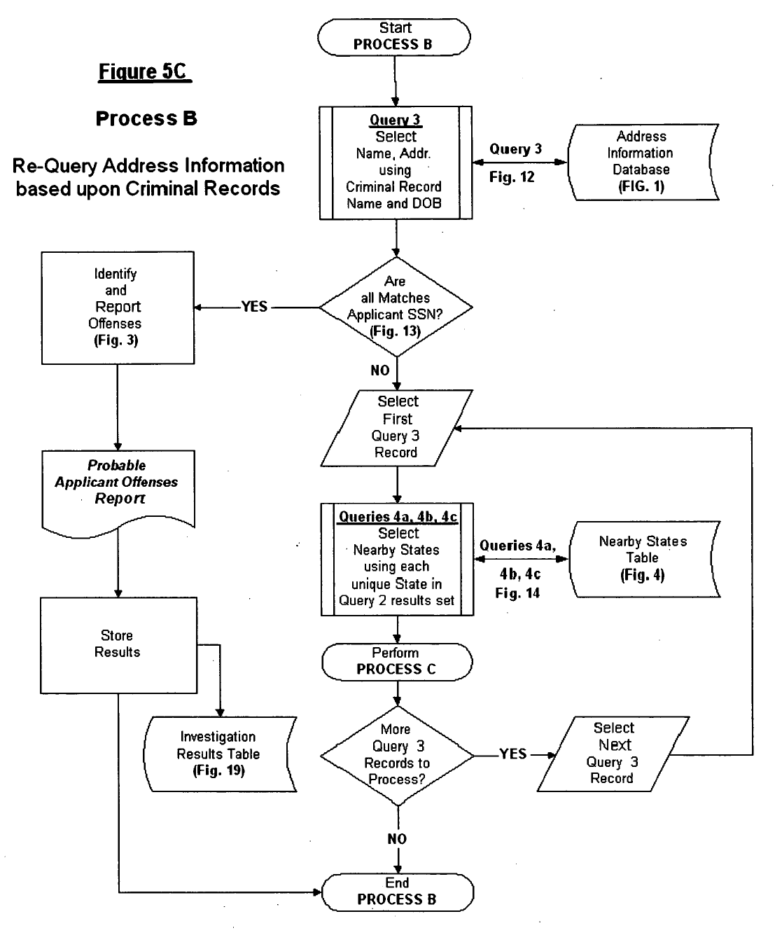

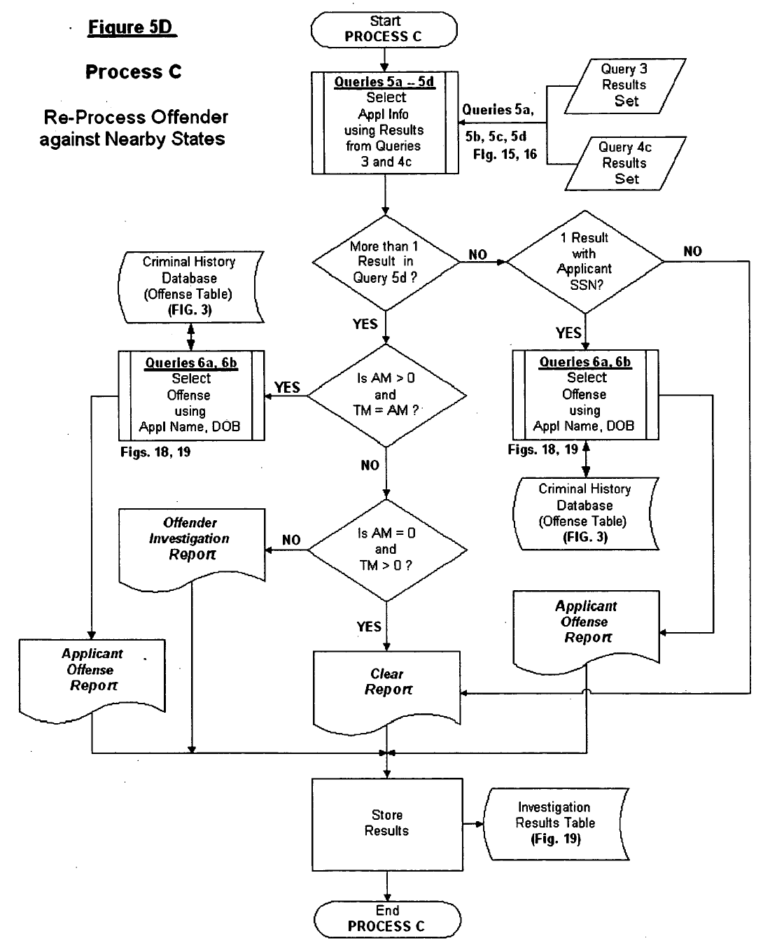

A typical Criminal History Database Structure is shown in FIG. 2 and FIG. 3. The essential elements of a criminal history database are its “table of offenders” (FIG. 2) and its “table of offenses” (FIG. 3). FIG. 2, the table of offenders may literally be a single table that combines data from multiple agencies, or multiple tables, each of which contain one or more agencies data on offenders. The table of offenders typically includes: (1) data structures of information about offenders linked to data structures of information about the offenses for which the offenders were arrested, charged, and/or convicted, and (2) a plurality of records with fields for each element of an offender's name, that is, first name, middle name, last name and suffix, or a full name field that combines these elements, date of birth (DOB), and various physical identifying characteristics of the offender, such as, sex, race, height and eye color, and the agency that houses the records, including its city, county and state. Search architecture for searching the records based upon various combinations of input parameters in the table of offenders, including offender names and dates of birth, is also provided and associated with the Criminal History Database.

FIG. 3, the table of offenses may literally be a single table that combines data from multiple agencies, or multiple tables, each of which contain one or more agencies data on offenses. The table of offenses table typically includes: (1) data structures of information about the offenses for which the offenders were arrested, charged, and/or convicted linked to data structures of information about the offenders, and (2) a plurality of records with fields that describe the offenses, the severity grading of the offenses, pertinent dates associated with the law enforcement and judicial processes, including dates of arrest, charge, conviction and sentencing, the disposition of the case and the sentence. Search architecture for searching the records for selected offenders based upon various combinations of input parameters in the table of offenses and for returning the offense data associated with the records returned by the query is also included and associated with the Criminal History Database. Here again, sample data have been added in both FIGS. 2 and 3 for illustrative purposes.

FIG. 4 is a table of those states that are near each state. If an offense was not committed by a resident of that state, it is more likely that it would have been committed by a resident of one of the surrounding states than those states that are more distant. The invention does not depend upon the criteria used to determine which, if any, states are considered “nearby” states, but nearby states are typically geographically connected to the state of interest. Note that only a sample of the 50 United States (together with corresponding nearby states) are depicted in FIG. 4 for illustrative purposes. Each embodiment of the subject invention involves determining whether the offender records returned by a query that includes the Applicant's first name, last name, and date of birth, apply to the Applicant. Once this determination has been made, those offense records that apply can be gathered using the data that links the offender records in the offenders' table with the offense records in the offenses table and reported for viewing via monitor and/or printer. Thus, the following description of a preferred embodiment of the subject system, apparatus and method for performing criminal background investigations, represented broadly by the flow diagrams of FIGS. 5A, 5B, 5C and 5D, teaches how queries of an address information database can be used to determine whether or not criminal history records returned by a query of the table of offenders in a criminal history database probably apply to an Applicant or whether additional research will be necessary to make this determination.

The subject method of performing a criminal background investigation of an Applicant is described in a series of flowchart-type diagrams (FIGS. 5A, 5B, 5C, 5D). FIG. 5A describes the Initiating (Main) Process of the invention. The process for the invention begins at the top of FIG. 5A (“Start MAIN PROCESS”) and ends at the bottom of FIG. 5A (“End MAIN PROCESS”). Within the Initiating, or Main, Process, several subordinate Processes are used to collect and analyze Applicant information. FIG. 5B describes the subordinate Process entitled “PROCESS A”. “PROCESS A” may be recursively executed multiple times based upon the number of records in the results set from Query 1c. FIG. 5C describes the subordinate Process entitled “PROCESS B”. “PROCESS B” may be recursively executed multiple times based upon the number of records in the results set from Query 2. FIG. 5D describes the subordinate Process entitled “PROCESS C”. “PROCESS C” is a decisioning Process that is executed during each iteration of Process B.

In a preferred embodiment, a criminal history background screening starts with entry by an Investigator of the Applicant's personal information into a user interface form (FIG. 6) of the system's software architecture. The user interface form includes data entry fields for the Applicant's first name, last name, date of birth and social security number. With the requisite information entered in the form, it is submitted to the Criminal History Database where the information is saved in the table of screening orders (FIG. 7) for use in later queries herein described.

The submitted SSN is used in Query 1a of Query Set 1 (FIG. 8) of the Address Information Database Table of Names and Addresses (FIG. 1). More specifically, Query 1a searches the Address Information Database based upon the Applicant's social security number to identify any other names the Applicant may have used. This step helps broaden the search to reduce the chances of reporting false negative results. Query 1a results are generated by the system's software architecture in the form of a results set that includes the first name, last name, dates of birth, street addresses, cities, counties, states and zip codes for those records in the Address Information Database associated with the entered SSN. Query 1a thus identifies all potential Applicant records, regardless of the name or date of birth, which are associated with the Applicant's SSN (to identify any other names the Applicant may have used, for example, a married woman's maiden name). Query 1b searches the results set of Query 1a using the Applicant's date of birth (to eliminate records which include the Applicant's social security number, but name and address data on a totally different person, which, at some point in the past, had been incorrectly entered and recorded in the address information database. Query 1b results are generated by the system's software architecture in the form of a results set that includes the first name, last name, and date of birth.

Any address records in the results set of FIG. 9A with a date of birth that does not match the Applicant's are probably the result of data entry errors in the sources of information for the address information database. In the event none of the names and/or dates of birth in the results set match the names and date of birth submitted in the user interface form of FIG. 6, the search is terminated, because information was either entered in error, or was misrepresented by the Applicant.

Query 1c examines the results set compiled by Query 1b and builds a result set (FIG. 9B) of the unique occurrences from the previous results set generated by Query 1b, each occurrence containing SSN, the first name, last name, and date of birth related to the Applicant. When the date of birth associated with a first name and last name in the results set of FIG. 9B matches the date of birth entered in the user interface form of FIG. 6, the names probably apply to the Applicant; either because the Applicant has used them or they represent different ways in which the Applicant's name has been entered into the address records.

Now reference is made to FIG. 5B (“PROCESS A”), the process to determine if the Applicant has committed a crime resulting in an existing record on the criminal history offenders table. Therefore, these names and the DOB are used in Query 2 of the table of offenders (FIG. 10). The result set of Query 2 is shown in FIG. 11. This result set includes the information about those offenders whose first name, last name and date of birth match those that the Applicant has used and appear in one or more of the agencies' criminal history repositories. For each offender, the result set identifies the agencies, the states where they are located, available information about the offenders' physical characteristics and the offenders' full names.

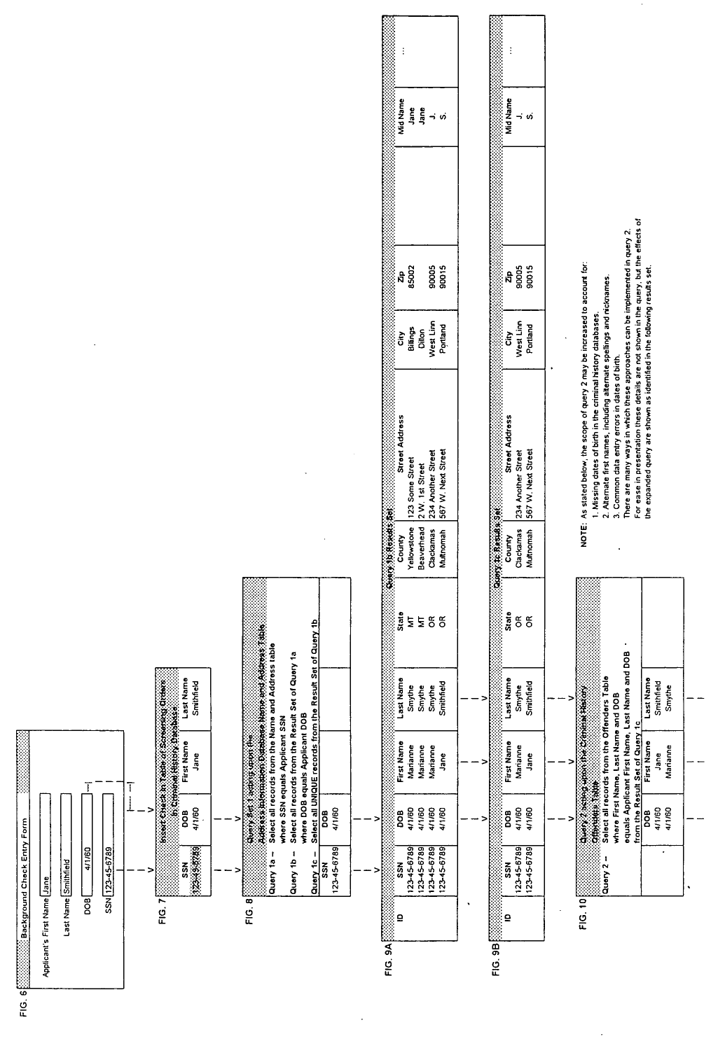

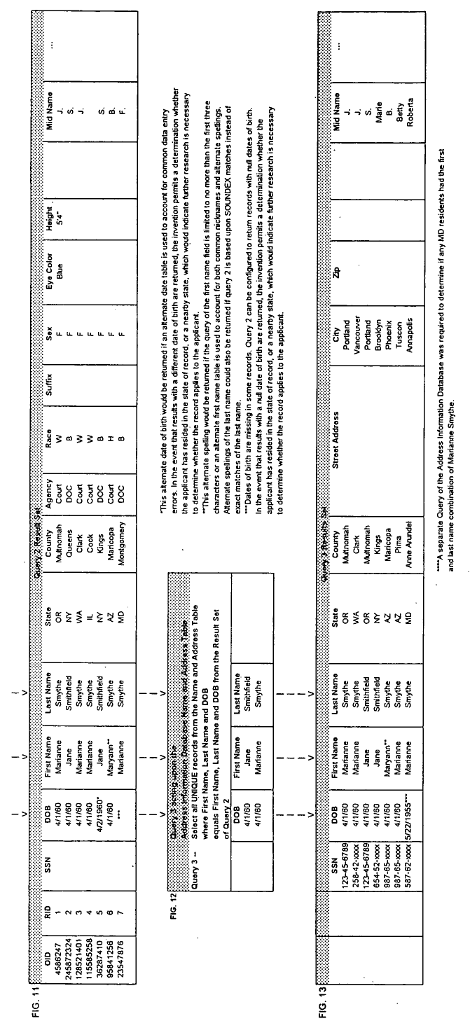

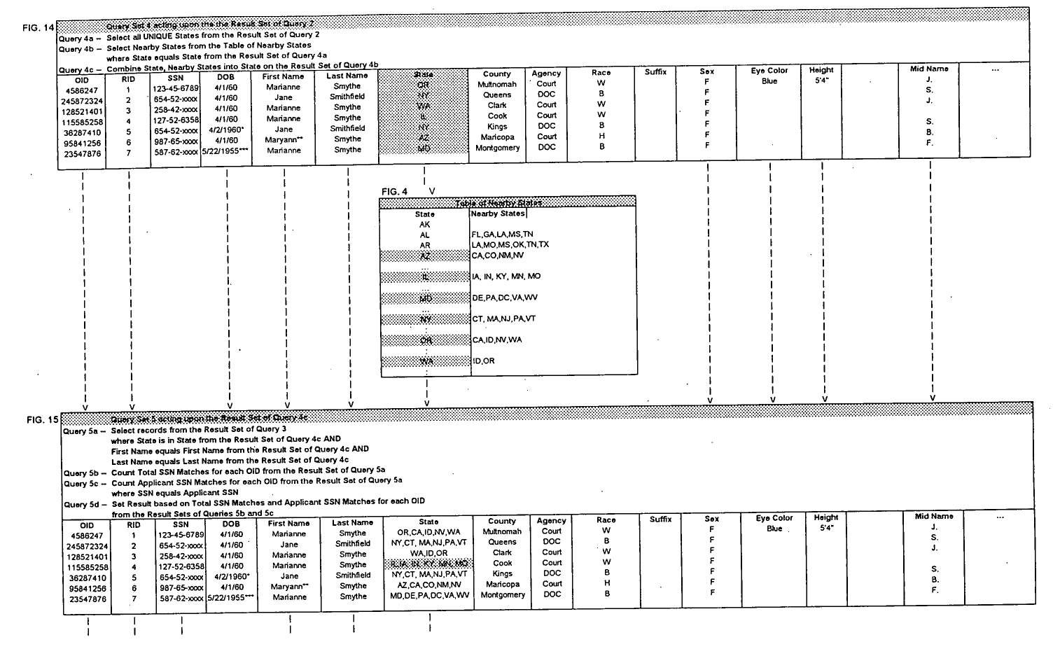

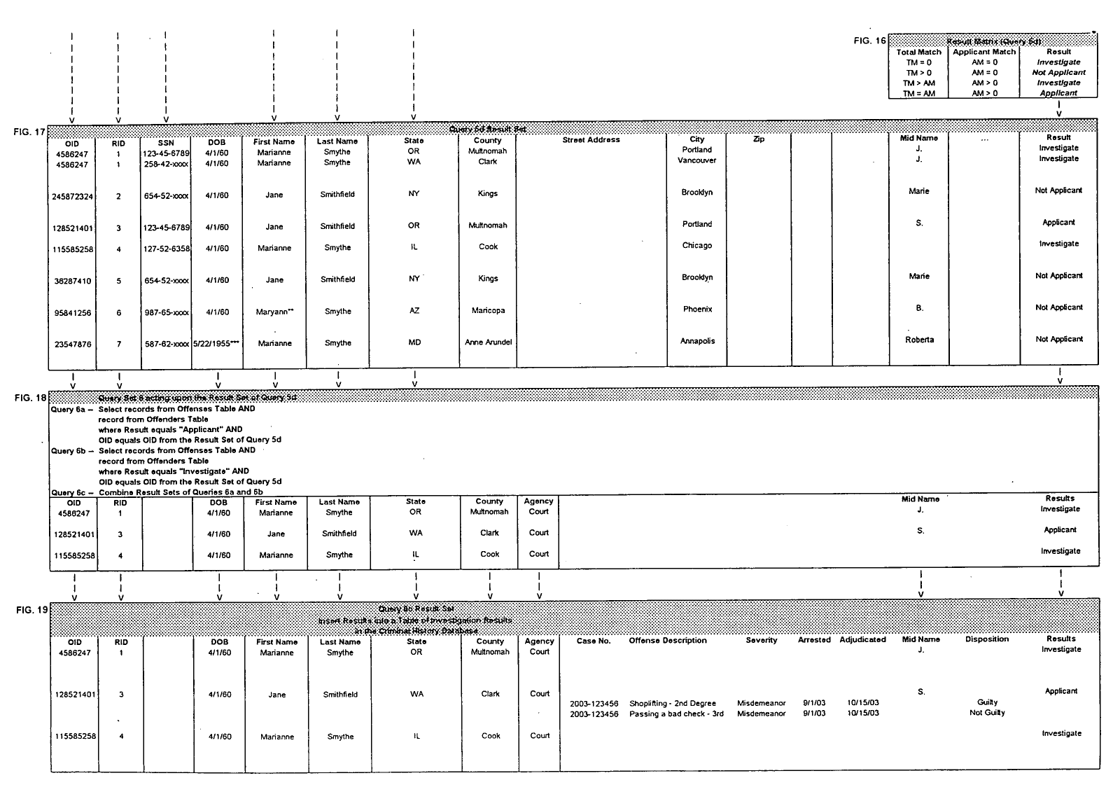

If Query 2 produces an empty (null) results set, a “Clear” report (indicating that the Applicant's information did not match any records on the criminal history offenders table) is generated for that record set. The resultant information (in this case, a “null” or empty record) is stored into the Investigation Results Table (FIG. 19) and PROCESS A ends.

Assuming that the result set of Query 2 is not null, reference is now made to FIG. 5C (“PROCESS B”), the process to re-query the Address Information Database using Query 3 (FIG. 12). Query 3 identifies, inter alia, other individuals who have the same first names, last names and date of birth as the Applicant, together with their corresponding social security number and address information that exists in the database. Note that some or all of these individuals may have criminal records and could be mistaken for the Applicant thereby producing a false positive report. A comparison of the social security numbers produced by Queries 1 and 3 is therefore performed. When only the Applicant's social security number appears in the Query 3 results set, the criminal offenses associated with the criminal history offender record are identified and reported and the search is considered complete for that Query 2 results record. A “Probable Applicant Offenses” report (indicating that the Applicant's information matched records on the criminal history offenders table) is generated for that record set. The resultant information is stored into the Investigation Results Table (FIG. 19) and PROCESS A ends.

If there is an SSN that is different from the Applicant's SSN in the results set of Query 3 (FIG. 13), the queries in Query Set 4 (FIG. 14) are performed. Query 4a selects all unique states from the results set of Query 2. Query 4b, using the results set generated in Query 4a, searches for a table entry for each unique state on the criminal history Table of Nearby States (FIG. 4), which enumerates the states surrounding the state of record. The results set for Query 4b is stored in an intermediate field for use by Query 4 c. Query 4 c combines the state of record and the surrounding states stored in the intermediate field and repopulates the values into the state of record field (as illustrated in the State field of FIG. 15). Thus, the state field now contains not only the state of record, but all “nearby” (surrounding) states for that state of record.

Reference is now made to FIG. 5D (“PROCESS C”). The queries in Query Set 5 are performed as follows: Query 5a selects records from the results set of Query 3 where the State of Record, the first name and the last name are equal to the results set for Query 4c. Query 5b uses the results set from Query 5a and counts the total SSN matches (identified in FIG. 16 as “Total Match” and “TM”) for each Offender ID (“OID”). Query 5c uses the results set from Query 5a and counts the total Applicant SSN matches (identified in FIG. 16 as “Applicant Match” and “AM”) for each Offender ID (“OID”) where the Offender SSN equals the Applicant SSN. Query 5d populates a Results field based on a matrix (FIG. 16) using the Total Match generated from Query 5b and the Applicant Match generated from Query 5c. FIG. 17 illustrates the completed result set from Query 5d with the Results field populated.

If Query 5d produces a results set with only one Offender record, a comparison is performed to see if the social security number on the Offender record is equal to the Applicant's social security number. If the social security number does not belong to the Applicant, then a “Clear” report is generated, indicating that the Offender is not the Applicant. The resultant information is stored into the Investigation Results Table (FIG. 19) and PROCESS A ends. If the social security number does belong to the Applicant, the criminal offenses associated with the criminal history offender record are identified and reported using Query Set 6 (FIGS. 18 and 19). An “Applicant Offense” report (indicating that the Applicant's information matched records on the criminal history offenders table) is generated for that Offender record. The resultant information is stored into the Investigation Results Table (FIG. 19) and PROCESS C ends.

If Query 5d produces a results set with more than one Offender record, a comparison is performed to determine if the Applicant Match is greater than zero and the Total Match equals the Applicant Match. If the comparison is true (“YES” on FIG. 5D), the criminal offenses associated with the criminal history offender record are identified and reported using Query Set 6 (FIGS. 18 and 19). An “Applicant Offense” report (indicating that the Applicant's information matched records on the criminal history offenders table) is generated for that Offender record. The resultant information is stored into the Investigation Results Table (FIG. 19) and PROCESS C ends. If the comparison is false (“NO” on FIG. 5D), a second comparison must be performed to determine if the Applicant Match is equal to zero and the Total Match is greater than zero. If the comparison is false (“NO” on FIG. 5D), the Offender must be further investigated and an “Offender Investigation” report is generated for the Offender record. The resultant information is stored into the Investigation Results Table (FIG. 19) and PROCESS C ends. If the comparison is true (“YES” on FIG. 5D), a “Clear” report is generated, indicating that the Offender is probably not the Applicant. The resultant information is stored into the Investigation Results Table (FIG. 19) and PROCESS C ends.

Based on the above description it should be appreciated that, in summary, the Initiating Process broadens the scope of the search by identifying name variations (alias') of an Applicant through a first query of an address information database, Process A produces a domain of criminal records based on each relevant name variant, Process B re-queries the address information database using each unique name in the domain of criminal records to generate a list of individuals with the Applicant's social security number (whose corresponding criminal records are reported as likely those of the Applicant) and with different social security numbers (whose corresponding criminal records may still relate to Applicant), and Process C, executing an automated decisioning logic process which evaluates geographic (state) information for each member of the latter group, determines whether their corresponding criminal history offender and offense records will be reported as those of the Applicant or whether further investigation is required to make this determination. The automated decisioning logic may be summarized as follows:
1. When the Applicant was the only person with the Applicant's name and date of birth who resided where a returned criminal history record was generated, there is reasonable assurance that the returned record applied to the Applicant.
2. When at least one person with the Applicant's name and date of birth resided where a returned criminal history record was generated but the Applicant did not reside there, there is reasonable assurance that the returned record did not apply to the Applicant.
3. When at least one other person (in addition to the Applicant), with the same name and date of birth, resided where a returned criminal history record was generated, additional research will be needed to determine whether the returned record applied to the Applicant.

Although the present invention has been described with reference to the particular embodiments herein set forth, it is understood that the present disclosure has been made only by way of example and that numerous changes in details of construction may be resorted to without departing from the spirit and scope of the invention. Thus, the scope of the invention should not be limited by the foregoing specifications, but rather only by the scope of the claims appended hereto.

1. An automated system for performing a criminal background investigation of a subject individual comprising:
at least one investigator having access to at least one address information database and at least one criminal history database, the investigator having apparatus for recording personal identification information of the individual and for generating electronic reports relating to the criminal history of the subject individual; and
a search architecture responsive to inputs by said at least one investigator for searching said address information database and said criminal history database, wherein each search comprises an accessing of said at least one address information database and of said at least one criminal history database, execution of a decisioning logic process to identify which criminal records produced by said at least one criminal information database pertain to the subject individual, and generation of a report setting forth those criminal records which relate to the subject individual, and those criminal records which may relate to the subject individual and require further investigation.

2. An automated system for performing a criminal background investigation of a subject individual comprising:
at least one investigator having access to at least one address information database and at least one criminal history database, the investigator having apparatus for recording personal identification information of the individual and for generating electronic reports relating to the criminal history of the subject individual; and
a search architecture responsive to inputs by said at least one investigator for searching said address information database and said criminal history database, wherein each search comprises the steps of:
1) performing a first query of said address information database using the social security number of the subject individual to identify name variations,
2) performing a query of said criminal information database using each of said name variations to identify a domain of criminal records which may relate to the subject individual,
3) performing a second query of said address information database using the first name, last name and date of birth of the subject individual to provide residence information about the subject individual and others with the same names and date of birth that can be automatically compared,
4) comparing the residence information,
5) executing a decisioning logic process to determine whether any of said criminal records in said domain relate to the subject individual, and
6) generating a report of the outcome of said decisioning logic process.
